(19) United States
(12) Patent Application Publication
(10) Pub. No.: US 2024/0428273 A1
(43) Pub. Date: Dec. 26, 2024

(54) Communication Channel Customization

(71) Applicant: Bank of America Corporation, Charlotte, NC (US)

(72) Inventors: Jinna Kim, Charlotte, NC (US); Katherine Dintenfass, Lincoln, RI (US); Vijaya L. Vemireddy, Plano, TX (US)

(21) Appl. No.: 18/213,413

(22) Filed: Jun. 23, 2023

(51) Int. Cl. G06Q 30/0201; G06Q 20/32

(52) U.S. Cl. CPC G06Q 30/0201; G06Q 20/3265

(57) ABSTRACT

Arrangements for communication channel customization are provided. In some aspects, historical data may be received from a plurality of data sources and used to train a machine learning model to generate recommended categories for association with users and customizations to communication schemes. Upon registering a user, user specific data may be received from data sources. The user specific data may be input to the machine learning model and, upon execution of the model, a recommended category for association with the user may be output. Based on the recommended category, a communication scheme may be retrieved and executed for the user. Subsequent user data may be received and used as inputs in the machine learning model. The model may be executed to output one or more customizations to the communication scheme. The one or more customizations may be transmitted to one or more computing systems and executed to further customize communications.

### BACKGROUND

Aspects of the disclosure relate to electrical computers, systems, and devices for using machine learning to customize communication channels between a user and an entity.

Enterprise organizations often implement generic terminology and communication methods that might not resonate with some users. While some conventional systems may rely on enterprise organization data associated with the user to customize a user experience, this customization based on objective data is not predictive in nature and does not allow for identification of more subjective passions of a user. According, arrangements provided herein leverage data received from various sources and predictive learning to identify users and customize execution of communications between the user and the enterprise organization.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with customizing communication channels between enterprise organizations and users.

In some aspects, historical data may be received from a plurality of data sources (e.g., internal data sources, external data sources) and used to train a machine learning model to generate recommended categories for association with users and customizations to communication schemes. Upon registering a user, user specific data may be received from a plurality of data sources. For instance, user specific data including self-reported data, internal data from an enterprise organization, external data from public sources, and the like, may be received. The user specific data may be used as inputs to the machine learning model and, upon execution of the model, the model may output a recommended category for association with the user. Based on the recommended category, a communication scheme may be retrieved and executed for the user.

In some examples, subsequent user data may be received and used as inputs in the machine learning model. The model may be executed to output one or more customizations to the identified communication scheme. The one or more customizations may be particular to the user. The one or more customizations may be transmitted to one or more computing systems or devices and executed to further customize communications between the enterprise organization and the user.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing communication customization in accordance with one or more aspects described herein;

FIGS. 2A-2K depict an illustrative event sequence for implementing communication customization in accordance with one or more aspects described herein;

FIG. 3 depicts an illustrative method for implementing communication customization in accordance with one or more aspects described herein;

FIGS. 4 and 5 illustrate graphical user interfaces that may be generated in accordance with one or more aspects described herein; and

FIG. 6 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, conventional systems implemented by enterprise organizations provide generic communication schemes when communicating with users or customers. Even in arrangements where some customization occurs, the customization may be based on objective data received by the enterprise organization. Accordingly, arrangements described herein leverage objective and subjective data from internal and external data sources to generate customized communication schemes for a user.

For instance, a machine learning model trained using historical data may be executed using user specific data obtained with permission of the user as inputs. The model may output a recommended category of association for the user. The category may be based on a user's employment area, hobbies, interests, or the like. A communication scheme associated with the category may be retrieved and executed for the user.

In some examples, subsequent user specific data may be received. The user specific data may be input to the machine learning model to output one or more customizations to the communication scheme executed for the user. The identified customizations may be executed to generate a communication scheme customized to the particular user. In some examples, the communication scheme customized to the particular user may include user specific settings directed to frequency of communication, type of communication channel or preferred communication channel to use for communications between the enterprise organization and user, type of lingo or terminology to present to the user in communications (e.g., modifying chat terminology to use, modifying terminology presented via a user interface in one or more channels or communication, or the like), audio settings such as pitch, volume, or speed, and the like. Additional user data may be received and further analyzed using machine learning to further customize the modified communication scheme, detect a triggering event that may prompt a request for user input, or the like.

These and various other arrangements will be discussed more fully below.

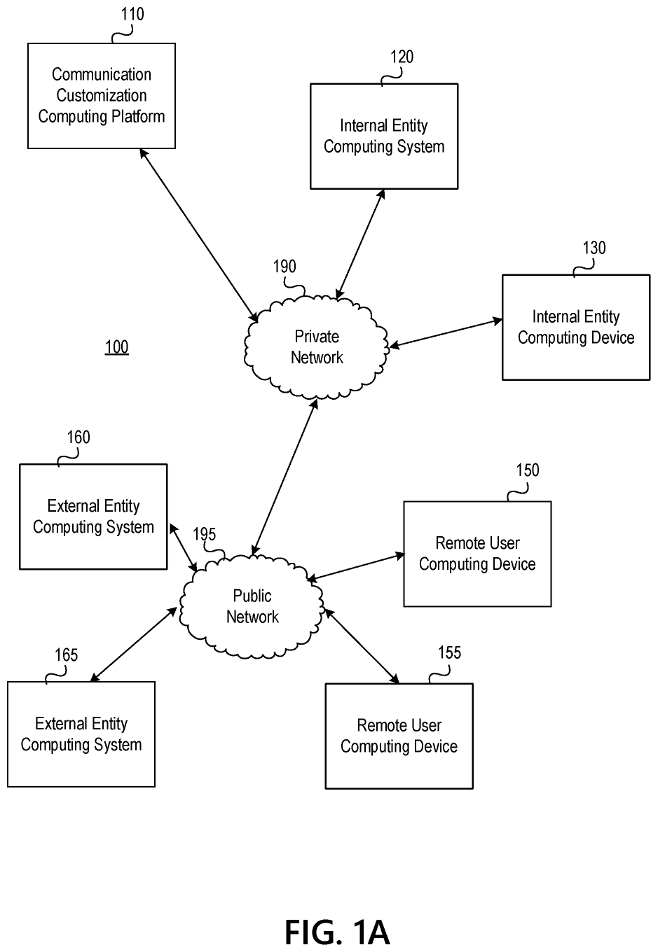

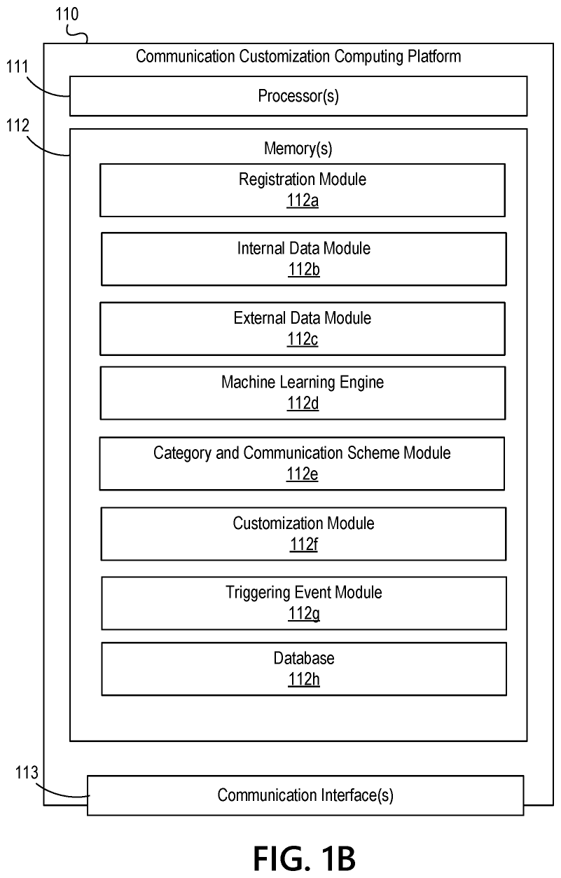

Aspects described herein may be implemented using one or more computing devices operating in a computing environment. For instance, FIGS. 1A-1B depict an illustrative computing environment for implementing customized communication in accordance with one or more aspects described herein. Referring to FIG. 1A, computing environment 100 may include one or more computing devices and/or other computing systems. For example, computing environment 100 may include communication customization computing platform 110, internal entity computing system 120, internal entity computing device 130, remote user computing device 150, remote user computing device 155, external entity computing system 160 and external entity computing system 165. Although one internal entity computing system 120, one internal entity computing device 130, two remote user computing devices 150, 155, and two external entity computing systems 160, 165 are shown, any number of devices or systems may be used without departing from the invention.

Communication customization computing platform 110 may be or include one or more computing devices (e.g., servers, server blades, or the like) and/or one or more computing components (e.g., memory, processor, and the like) and may be configured to provide dynamic, efficient communication customization. In some examples, communication customization computing platform 110 may receive historical user data associated with user interactions with one or more computing devices, systems, interfaces, or the like, as well as historical data associated with user demographics transaction history, payment history (e.g., payroll records for a user based on funds received by the enterprise organization), public records, social media data, and the like. The data may be received from internal sources, such as internal entity computing system 120 and/or external sources, such as external entity computing system 160 and/or external entity computing system 165.

The historical data may be used to train a machine learning model. For instance, in some examples, the historical data may be labeled data indicating user demographics, transaction data labels, payment data, employment data, interest or hobby data (e.g., based on transaction data), or the like and may be used to train the machine learning model to identify patterns or sequences in data and output a recommended category of a user for a communication scheme, as well as generated or outputting one or more communication customization recommendations.

In some examples, user specific data may be input into the machine learning model and the model may be executed to output a recommended category for the user and/or additional communication customizations. In some examples, the user specific data may be self-reported data received from a user computing device (e.g., remote user computing device 150). For instance, data such as self-identified interests, neurodiversity, hobbies, interests, or the like, may be provided by the user (e.g., during a registration process) and used to customize communication for the user. Additionally or alternatively, user specific data may include transaction data, payroll or employment data, and the like, received from an internal system, such as internal entity computing system 120. Further, in some examples, the user specific data may include public data (or data held by a third party and provided via user authorization) such as social media data, public records, and the like, and may be received from, for instance, external entity computing system 160.

The user specific data may be input to the machine learning model to generate or output a recommended category for the user. For instance, users may be assigned one or more predefined categories, such as musician, performing artists, sports enthusiast, travel enthusiast, or the like. Various other categories may be used without departing from the invention. In some examples, a category may be identified based on a neurodiversity provided by the user.

Based on the generated category, a communication scheme may be identified for the user. In some examples, the communication scheme may include predetermined customizations established for users in that category. For instance, for users who are musicians, communication to the user may be in context of “gigs” rather than salary. In some examples, because musicians may receive payments on a less regular schedule than a salaried worker, communications to the user may be times to align with payments received and/or particular services or products may be recommended to the musician (e.g., “have you considered the tax implications of your current pay scheme?”). Various other examples may be used without departing from the invention.

The user may then continue executing transactions, interacting with devices, and the like, and additional user specific data may be captured and analyzed using the machine learning engine. The machine learning engine may output one or more additional recommendations for further customization (e.g., this person is a musician but also is a performing artist and has a studio space. Accordingly, recommendations for additional products or services, and/or schedule or nature of communications may be further modified (e.g., the category communication scheme may be modified for that user to accommodate additional insights obtained from the additional user specific data)).

In some examples, communication customization computing platform 110 may receive additional user data and detect a triggering event, such as a change in payroll payments, change in spending habits, or the like. Accordingly, the communication customization computing platform 110 may generate a request for user input confirming whether the identified category is still accurate or if another category may be more accurate for customization for the user. The notification may be sent to a user computing device and response data may be received and analyzed.

Communication customization computing platform 110 may update, validate or the like, the machine learning model based on additional user specific data, user response data, and the like. Accordingly, the machine learning model may be continuously updated to improve accuracy of category recommendations, communication scheme customizations, and the like.

Internal entity computing system 120 may be or include one or more computing devices (e.g., servers, server blades, or the like) and/or one or more computing components (e.g., memory, processor, and the like) and may host or execute one or more enterprise organization applications, systems, or the like. Accordingly, internal entity computing system 120 may store user information (e.g., transaction data, product data, demographic data, and the like) that may be used to train the machine learning model. Further, internal entity computing system 120 may store user specific data (e.g., current transaction data, payroll or employment data, and the like) that may be analyzed using the trained machine learning model to generate one or more recommended categories or communication scheme customizations.

Internal entity computing device 130 may be or include one or more computing devices, such as desktop computers, laptop computers, tablet computers, smartphones, wearable devices such as smart watches or augmented reality glasses, or the like. In some examples, internal entity computing device 130 may be a self-service kiosk, such as an automated teller machine (ATM), automated teller assistant (ATA), or the like. In some examples, internal entity computing device 130 may be a computing device associated with the enterprise organization but operated by a user (e.g., a customer), such as a tablet device used at a banking center.

Remote user computing device 150 and/or remote user computing device 155 may be or include computing devices such as desktop computers, laptop computers, tablets, smartphones, wearable devices, and the like, that may be associated with a user (e.g., a customer of the enterprise organization). The remote user computing device 150 and/or remote user computing device 155 may be used to communicate with the communication customization computing platform 110 to provide user input, receive and display notifications, access enterprise data via an online or mobile banking application, communicate with the enterprise organization via a telephone channel, and the like. In some examples, remote user computing device 150 may be associated with a same user as remote user computing device 155. In other examples, remote user computing device 150 may be associated with a different user than remote user computing device 155.

External entity computing system 160 and/or external entity computing system 165 may be or include computing devices (e.g., servers, server blades, or the like), components (e.g., processor, memory, or the like), and the like, associated with an entity external to or different from the enterprise organization. External entity computing system 160 and/or external entity computing system 165 may store publicly available data (e.g., tax records, property records, or the like), social media data, or the like, that may be used to train a machine learning model. In some arrangements, external entity computing system 160 and/or external entity computing system 165 may include user specific data that may be analyzed (e.g., using machine learning) to generate one or more recommended categories or communication scheme modifications.

As mentioned above, computing environment 100 also may include one or more networks, which may interconnect one or more of communication customization computing platform 110, internal entity computing system 120, internal entity computing device 130, remote user computing device 150, remote user computing device 155, external entity computing system 160 and external entity computing system 165. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, communication customization computing platform 110, internal entity computing system 120, and/or internal entity computing device 130, may be associated with an enterprise organization (e.g., a financial institution), and private network 190 may be associated with and/or operated by the organization, and may include one or more networks (e.g., LANs, WANs, virtual private networks (VPNs), or the like) that interconnect communication customization computing platform 110, internal entity computing system 120, and/or internal entity computing device 130, and one or more other computing devices and/or computer systems that are used by, operated by, and/or otherwise associated with the organization. Public network 195 may connect private network 190 and/or one or more computing devices connected thereto (e.g., communication customization computing platform 110, internal entity computing system 120, internal entity computing device 130) with one or more networks and/or computing devices that are not associated with the organization. For example, remote user computing device 150, remote user computing device 155, external entity computing system 160 and/or external entity computing system 165 might not be associated with an organization that operates private network 190 (e.g., because remote user computing device 150, remote user computing device 155, external entity computing system 160 and/or external entity computing system 165 may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect remote user computing device 150, remote user computing device 155, external entity computing system 160 and/or external entity computing system 165 to private network 190 and/or one or more computing devices connected thereto (e.g., communication customization computing platform 110, internal entity computing system 120, internal entity computing device 130).

Referring to FIG. 1B, communication customization computing platform 110 may include one or more processors 111, memory 112, and communication interface 113. A data bus may interconnect processor(s) 111, memory 112, and communication interface 113. Communication interface 113 may be a network interface configured to support communication between communication customization computing platform 110 and one or more networks (e.g., network 190, network 195, or the like). Memory 112 may include one or more program modules having instructions that when executed by processor(s) 111 cause communication customization computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of communication customization computing platform 110 and/or by different computing devices that may form and/or otherwise make up communication customization computing platform 110.

For example, memory 112 may have, store and/or include registration module 112a. Registration module 112a may store instructions and/or data that may cause or enable the communication customization computing platform 110 to receive registration data. In some examples, the registration data may include identification of one or more users requesting registration (e.g., providing permission to receive and analyze user specific data to generate categories and/or customizations of communication schemes), one or more user device identifiers, and the like. In some examples, the registration data may include self-reported information about the user (e.g., user hobbies or interests, area of employment, or the like).

Communication customization computing platform 110 may further have, store and/or include internal data module 112b. Internal data module 112b may store instructions and/or data that may cause or enable the communication customization computing platform 110 to receive internal data from one or more internal systems or devices, such as internal entity computing system 120. The data may be received in a data stream, via a batch transfer process, or the like. The data may be used to train a machine learning model. Further, user specific data may be requested from the internal entity computing system 120 and stored by the internal data module 112b for use in analyzing the user specific data to generate one or more user categories, communication scheme customizations, or the like.

Communication customization computing platform 110 may further have, store and/or include external data module 112c. External data module 112c may store instructions and/or data that may cause or enable the communication customization computing platform 110 to receive external data from one or more external systems or devices, such as external entity computing system 160, external entity computing system 165, or the like. The data may be received in a data stream via a batch transfer process, or the like. The data may be used to train a machine learning model. In some examples, user specific data may be retrieved from the external entity computing system 160 and/or external entity computing system 165 by the external data module and analyzed, using machine learning, to generate one or more system or user interface modifications for execution.

Communication customization computing platform 110 may further have, store and/or include machine learning engine 112d. Machine learning engine 112d may store instructions and/or data that may cause or enable the communication customization computing platform 110 to train, execute, validate and/or update one or more machine learning models that may be used to analyze user specific data to identify a user category and identify one or more communication scheme customizations. In some examples, the machine learning model may be trained (e.g., using data received from one or more internal data sources, external data sources, from the user, and the like) to identify patterns or sequences in data to generate or output a recommended category of the user and/or communication scheme customizations. For instance, the machine learning model may receive, as inputs, user specific data for a user and, upon execution of the machine learning model, may output a category with which the user should be associated (e.g., based on employment, hobbies, interests, transaction data, or the like). In some examples, the user specific data may be received from internal sources (e.g., internal entity computing system 120) and/or external sources (e.g., external entity computing system 160, external entity computing system 165, or the like). The model may be executed based on the inputs to output one or more categories and/or to generate one or more communication scheme customizations. In some examples, a dynamic feedback loop may be used to provide, to the machine learning model, information related to the recommended category, communication scheme customizations, additional user data, and the like to continuously update the model and improve accuracy of recommendations or optimize outputs of the model. In some examples, dynamic feedback loop may be based on data captured via one or more systems or devices and/or user input received from a user (e.g., in response to a notification or request for confirmation).

In some examples, the machine learning model may be or include one or more supervised learning models (e.g., decision trees, bagging, boosting, random forest, neural networks, linear regression, artificial neural networks, logical regression, support vector machines, and/or other models), unsupervised learning models (e.g., clustering, anomaly detection, artificial neural networks, and/or other models), knowledge graphs, simulated annealing algorithms, hybrid quantum computing models, and/or other models. In some examples, training the machine learning model may include training the model using labeled data (e.g., data labeled to indicate demographic data, employment area, hobbies, interests, or the like).

Communication customization computing platform 110 may further have, store and/or include category and communication scheme module 112e. Category and communication scheme module 112e may store instructions and/or data that may cause or enable the communication customization computing platform 110 to receive outputs from the machine learning engine 112d (e.g., from machine learning model) identifying a category to be associated with a user. Based on the identified or output category, category and communication scheme module 112e may retrieve (e.g., from database 112h) a communication scheme to associate with or execute for the user. For instance, the communication scheme may include a default set of customizations for users in the identified category (e.g., frequency of communication, channel of communication, type of communication, terminology used within communications, and the like). The identified communication scheme may then be executed for the user and may be further customized based on additional user specific data analyzed using the machine learning model.

In some examples, a plurality of categories may be identified from historical data using logical clusters of users within an overall population, subset of the population, or the like. For instance, based on public data, clusters of users based on, for instance, employment, or other topic may be identified. Additional categories may be identified as additional data is received and analyzed.

Communication customization computing platform 110 may further have, store and/or include customization module 112f. Customization module 112f may store instructions and/or data that may cause or enable the communication customization computing platform 110 to identify (e.g., based on analysis, by the machine learning model, of additional user specific data) customizations of the communication scheme and generate an instruction causing a system, device, application or the like, to further customize the communication scheme and associated communication settings based on the identified customizations. For instance, if the communication scheme for a first user includes a default setting to send communications once per month, and further analyzed user specific data indicates that the user prefers to receive communications more frequently, the communication scheme applied for or executed for that user may be modified or customized to increase the frequency of communications for that user (e.g., for only that user and not for all users associated with the communication scheme of that category).

Communication customization computing platform 110 may further have, store and/or include triggering event module 112g. Triggering event module 112g may store instructions and/or data that may cause or enable the communication customization computing platform 110 to receive subsequent user specific data and analyze (e.g., using machine learning) the subsequent user data to determine whether a triggering event has occurred (e.g., a change or shift in interests or hobbies (e.g., as evidenced by changes in transaction habits), a change in employment or employment area, or the like). If so, the triggering event module 112g may generate a notification requesting user input confirming a current categorization for the user or asking for identification or selection of a new category for the user. In some examples, the notification may include multiple potential categories identified from the analyzed data and the user may select one or may select more than one in ranked order of interest. The notification may be transmitted or sent to remote user computing device 150 and displayed.

Communication customization computing platform 110 may further have, store and/or include database 112h. Database 112h may store data associated with historical user data, generated categories or customizations, a plurality of categories and associated communication schemes, and/or other data that enables performance of the aspects described herein by the communication customization computing platform 110.

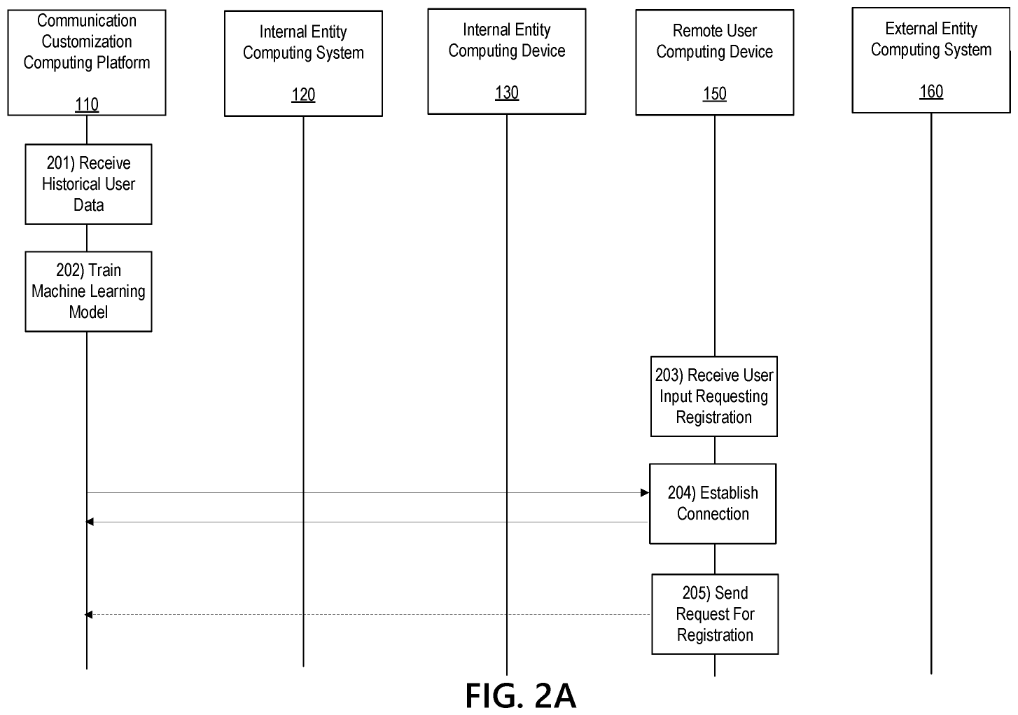

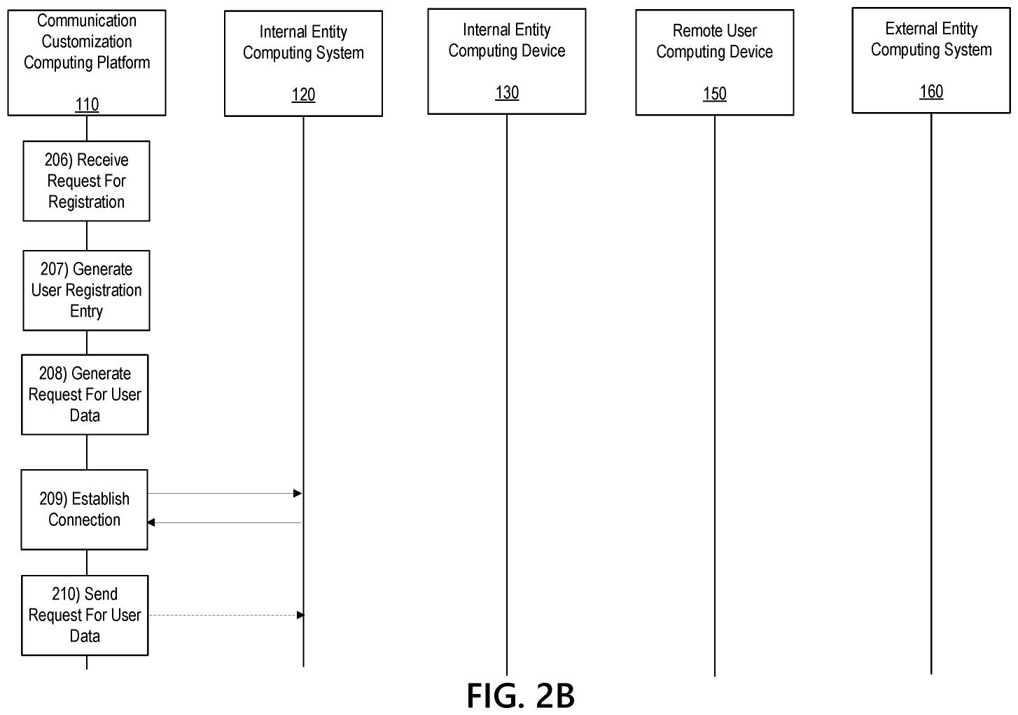

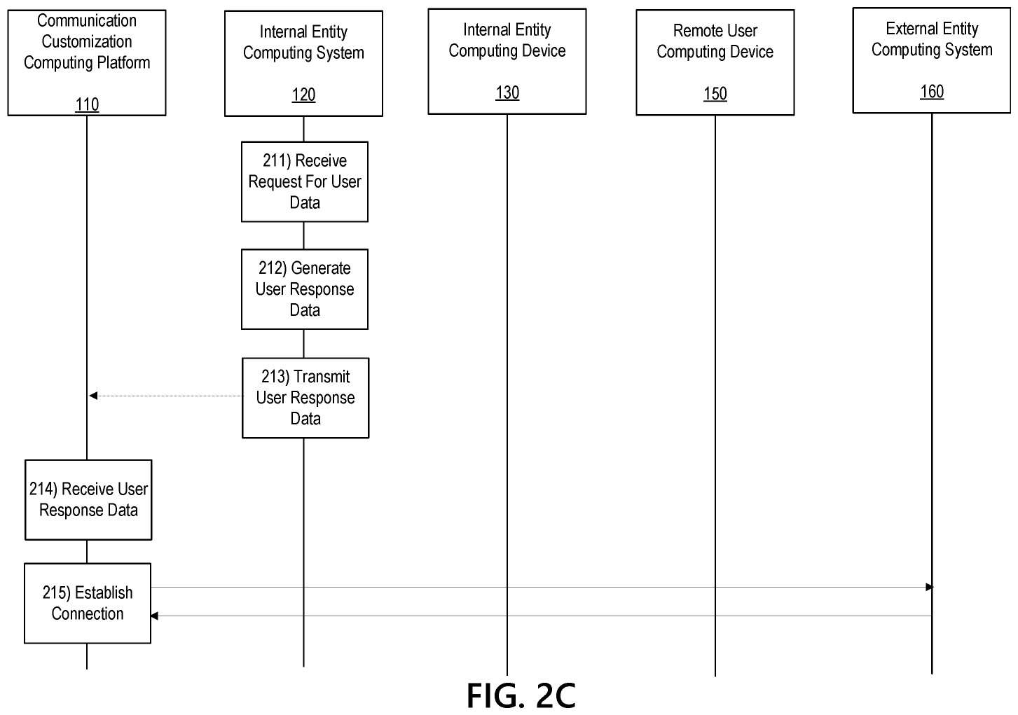

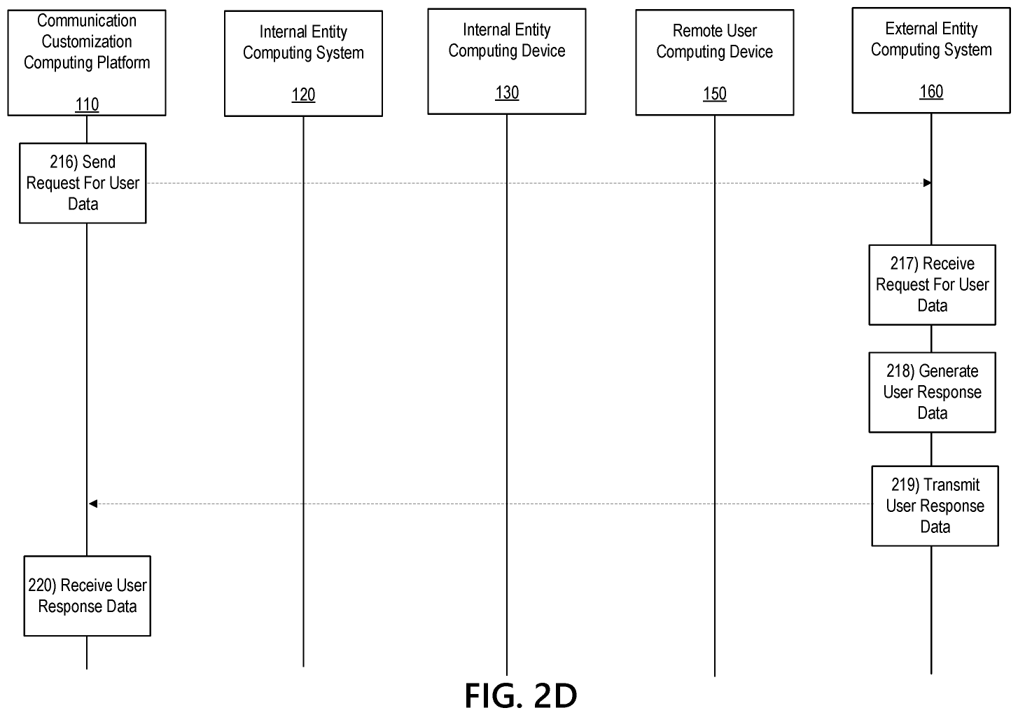

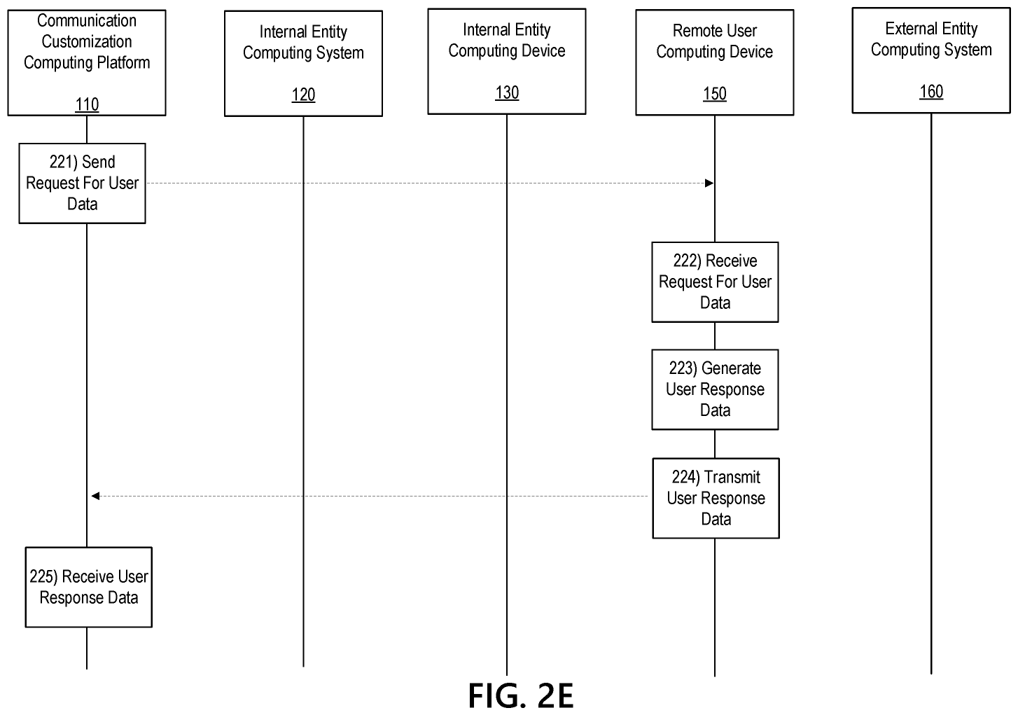

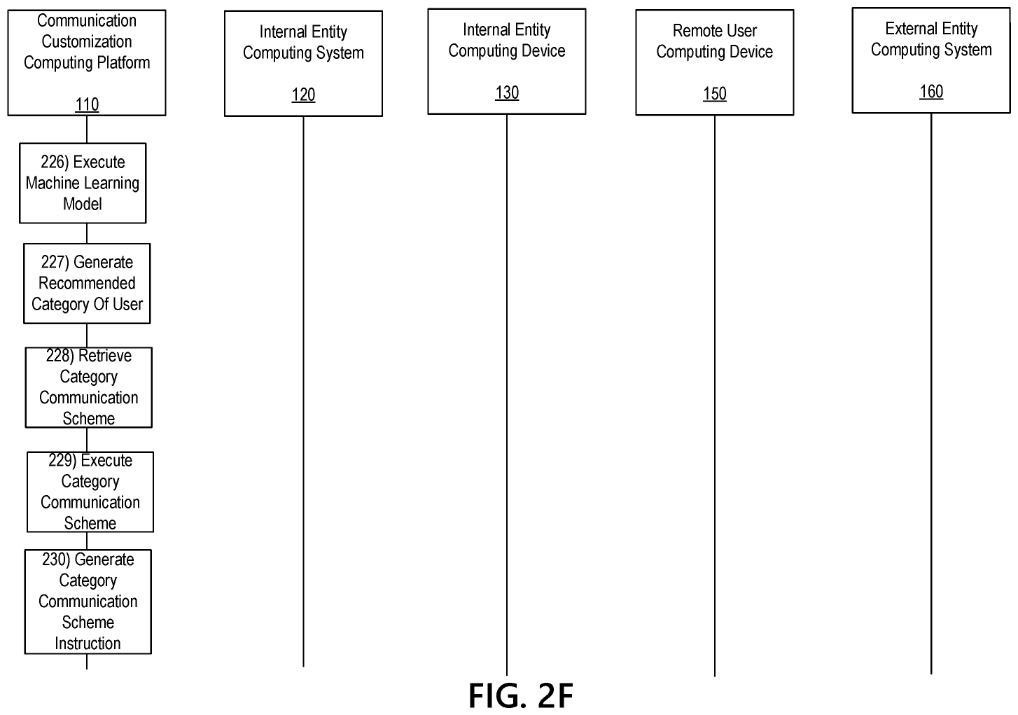

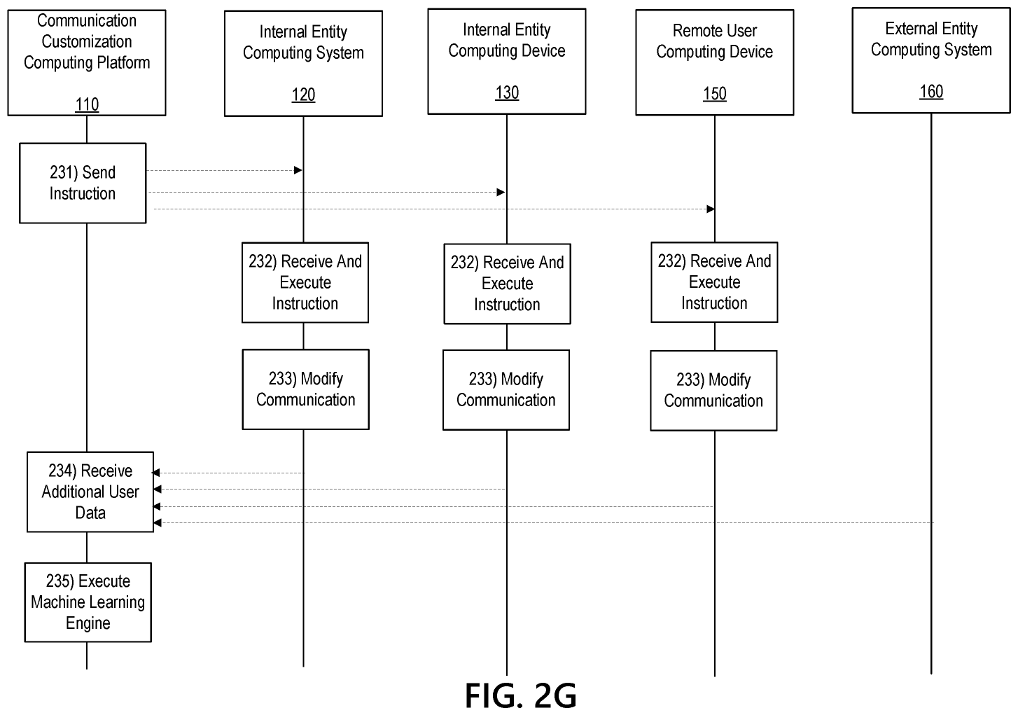

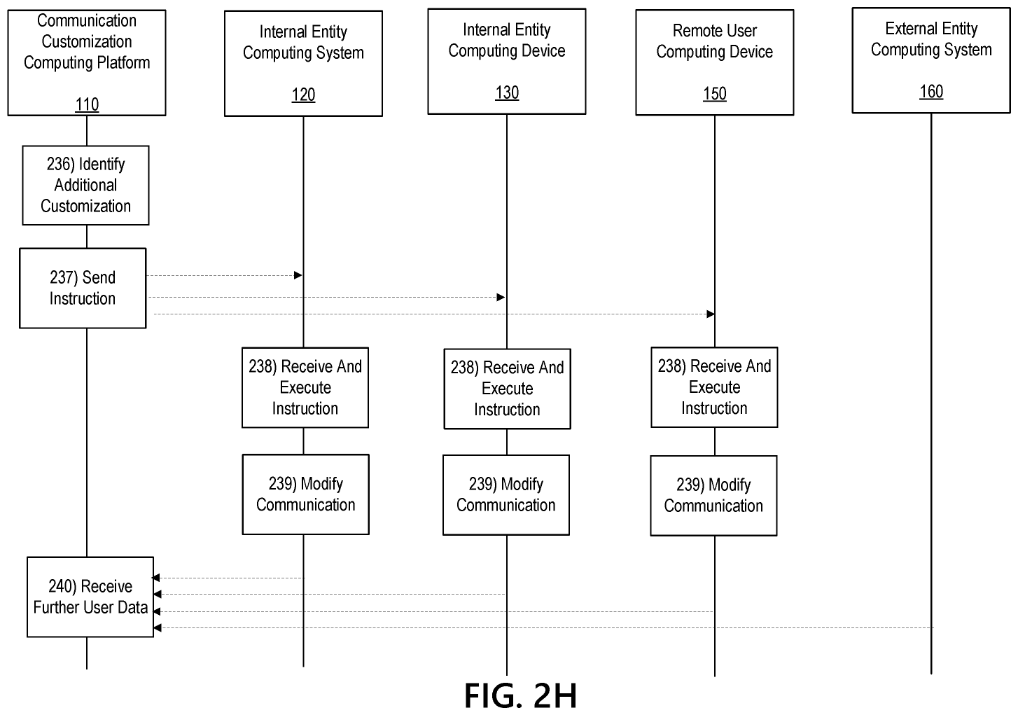

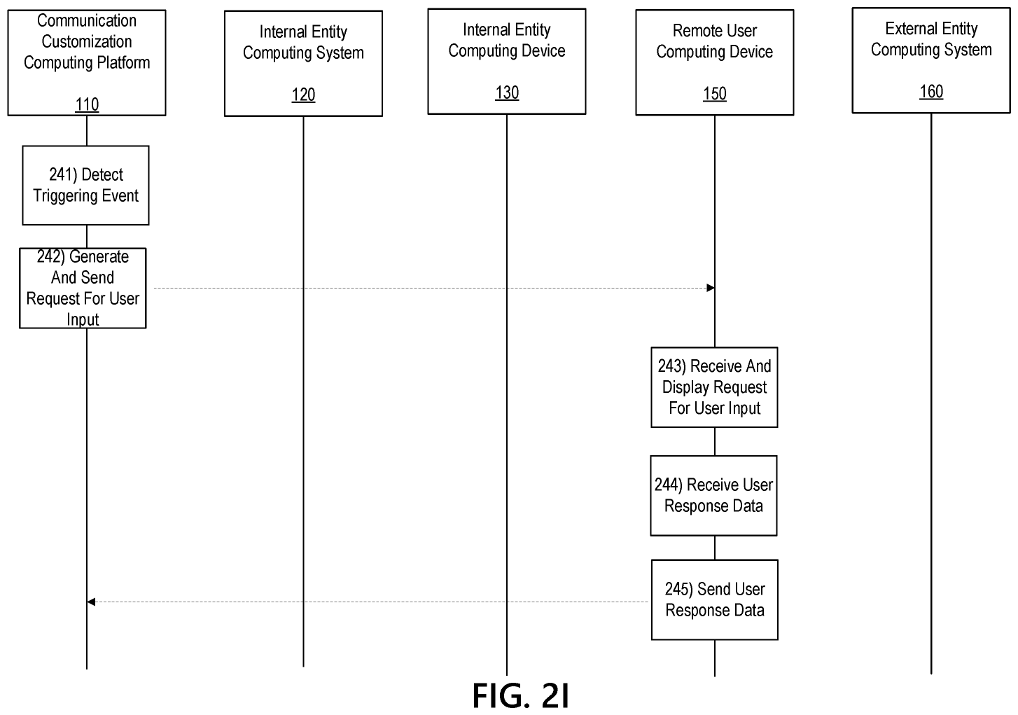

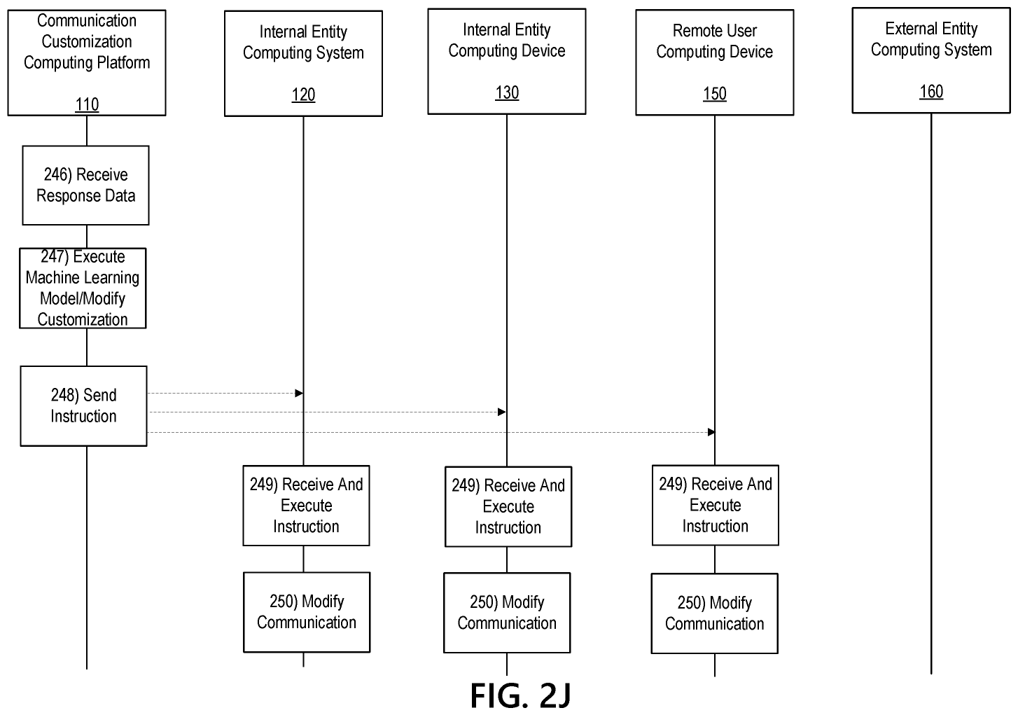

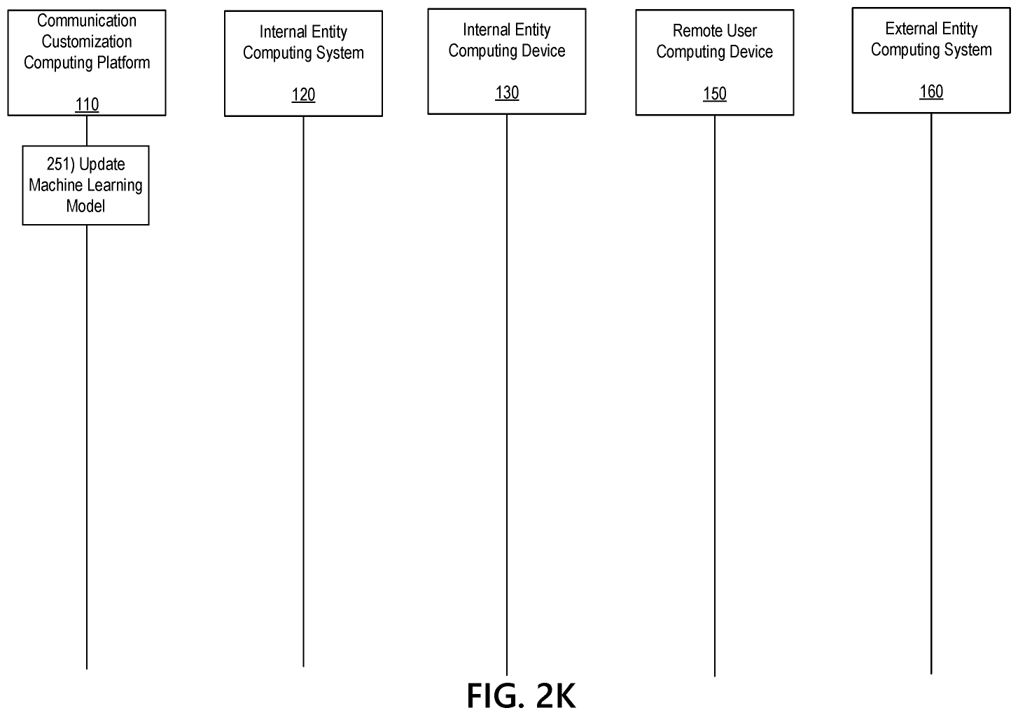

FIGS. 2A-2K depict one example illustrative event sequence for implementing communication customization in accordance with one or more aspects described herein. The events shown in the illustrative event sequence are merely one example sequence and additional events may be added, or events may be omitted, without departing from the invention. Further, one or more processes discussed with respect to FIGS. 2A-2K may be performed in real-time or near real-time.

With reference to FIG. 2A, at step 201, communication customization computing platform may receive historical data. As discussed herein, the historical data may include user demographic data, transaction data, interest data, social media data, public records data, self-reported data, and the like. In some examples, the historical data may include internal data (e.g., data from one or more systems associated with the enterprise organization, such as internal entity computing system 120) and/or external data (e.g., publicly available data from one or more systems external to the enterprise organization, such as external entity computing system 160, external entity computing system 165, and the like). The data may include publicly available data, such as tax records, social media data, and the like. In some examples, the data received may provide a context for a user (e.g., life stage, interests, job role, hobbies, or the like).

At step 202, the communication customization computing platform 110 may train a machine learning model. For instance, the communication customization computing platform 110 may train, using the received historical data, the machine learning model to generate one or more categories to associate with a user, one or more communication scheme customizations, and the like. In some examples, training the machine learning model may include using labeled data (e.g., demographic, hobby, employment data, or the like) to train the machine learning model to identify patterns or sequences in user specific data in order to output a recommended category or communication scheme customization.

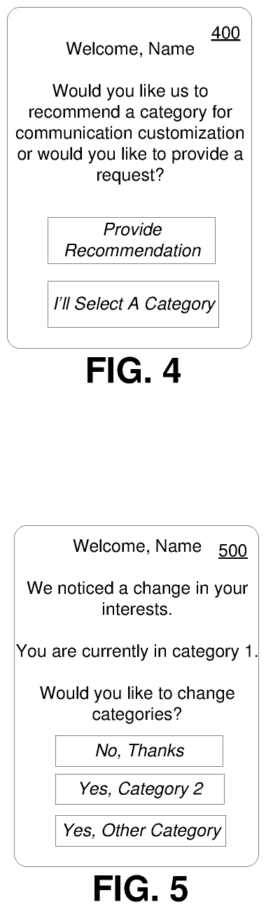

At step 203, a remote user computing device 150 may receive user input requesting registration with the communication customization computing platform 110. For instance, remote user computing device 150 may receive user input via a touchscreen, keypad, or the like, and from a user associated with remote user computing device 150, a request to register with the communication customization computing platform 110. In some examples, the request for registration may include user permissions for the communication customization computing platform 110 to receive and analyze user specific data to generate one or more categories, communication scheme customizations, and the like. The request for registration may further include user identifying data, user device identifying data, and the like. In some examples, request for registration may include a group or other category with which the user particularly identifies. In some arrangements, a user may select the group or category with which to be associated or may request the computing platform to generate a machine learning-based recommendation for a category based on the user data. In some examples, user input identifying or requesting one or more category maybe provided in response to a request from the communication customization computing platform 110 to provide the information. For instance, FIG. 4 illustrates one example user interface 400 that may be presented to the user (e.g., via remote user computing device) during the registration process to determine whether to generate a machine learning-based category or use a user provided category. The user interface 400 may provide a user option to have the system generate a recommended category or have the user provide a category. If the option for the user to provide the category is selected, another user interface may be displayed including a field where a user may provide input identifying one or more categories, a drop down list of categories for selection may be provided, or the like.

At step 204, remote user computing device 150 may establish a connection with the communication customization computing platform 110. For instance, a first wireless connection may be established between the remote user computing device 150 and the communication customization computing platform 110. Upon establishing the first wireless connection, a communication session may be initiated between the remote user computing device 150 and the communication customization computing platform 110.

At step 205, remote user computing device 150 may transmit or send the request for registration to the communication customization computing platform 110. For instance, the remote user computing device 150 may transmit or send the request for registration during the communication session initiated upon establishing the first wireless connection.

With reference to FIG. 2B, at step 206, the communication customization computing platform 110 may receive the request for registration.

At step 207, the communication customization computing platform 110 may generate a user registration entry in response to receiving the request for registration. For instance, communication customization computing platform 110 may modify a database (e.g., database 112h) to include user registration data, user permission data, and the like.

At step 208, communication customization computing platform 110 may generate a request for user specific data. For instance, the communication customization computing platform 110 may generate a request for user specific data associated with the user associated with the request for registration. The request for user specific data may include a request for internal data (e.g., user transaction data, demographic data, employment information, and the like), external data (e.g., social media data, property record data, and the like) and/or self-reported data from the user.

At step 209, communication customization computing platform 110 may establish a connection with the internal entity computing system 120. For instance, a second wireless connection may be established between the communication customization computing platform 110 and internal entity computing system 120. Upon establishing the second wireless connection, a communication session may be initiated between the communication customization computing platform 110 and the internal entity computing system 120.

At step 210, communication customization computing platform 110 may transmit or send the request for user specific data to the internal entity computing system 120. For instance, the communication customization computing platform 110 may transmit or send the request for user specific data during the communication session initiated upon establishing the second wireless connection.

With reference to FIG. 2C, at step 211, internal entity computing system 120 may receive the request for user specific data. In response to receiving the request, internal entity computing system 120 may identify user specific data associated with the user (e.g., transaction data, demographic data, employment data, and the like).

At step 212, internal entity computing system 120 may generate user specific response data. For instance, based on the identified data, the internal entity computing system 120 may generate user specific response data.

At step 213, internal entity computing system 120 may transmit or send the user specific response data to the communication customization computing platform 110.

At step 214, communication customization computing platform 110 may receive the user specific response data transmitted by the internal entity computing system 120.

At step 215, communication customization computing platform 110 may establish a connection with the external entity computing system 160. For instance, a third wireless connection may be established between the communication customization computing platform 110 and external entity computing system 160. Upon establishing the third wireless connection, a communication session may be initiated between the communication customization computing platform 110 and the external entity computing system 160.

With reference to FIG. 2D, at step 216, communication customization computing platform 110 may transmit or send the request for user specific data to the external entity computing system 160. For instance, the communication customization computing platform 110 may transmit or send the request for user specific data during the communication session initiated upon establishing the third wireless connection.

At step 217, external entity computing system 160 may receive the request for user specific data. In response to receiving the request, external entity computing system 160 may identify user specific data associated with the user (e.g., public records data, social media data, and the like).

At step 218, external entity computing system 160 may generate user specific response data. For instance, based on the identified data, the external entity computing system 160 may generate user specific response data.

At step 219, external entity computing system 160 may transmit or send the user specific response data to the communication customization computing platform 110.

At step 220, communication customization computing platform 110 may receive the user specific response data transmitted by the external entity computing system 160.

With reference to FIG. 2E, at step 221, communication customization computing platform 110 may transmit or send the request for user specific data to the remote user computing device 150. For instance, the communication customization computing platform 110 may generate one or more user interfaces requesting user information (e.g., information about employment, interests, hobbies, and the like) and transmit or send the request to the remote user computing device 150. In some examples, the notification may be sent via an application of the enterprise organization executing on remote user computing device 150, such as a mobile application. In some examples, transmitting or sending the notification may cause it to display on a display of remote user computing device 150.

At step 222, remote user computing device 150 may receive the request for user specific, self-reported data. In response to receiving the request, remote user computing device 150 may display the notifications and request user input providing the requested user data.

At step 223, remote user computing device 150 may receive, e.g., via a touchscreen or other input device, user input providing the requested user data and remote user computing device may generate user response data from the user input.

At step 224, remote user computing device 150 may transmit or send the user specific response data to the communication customization computing platform 110.

At step 225, communication customization computing platform 110 may receive the user response data transmitted by the remote user computing device.

Although requests for user data are shown as being sent to one internal entity computing system 120, one remote user computing device 150, and one external entity computing system 160, requests for user data may be sent to additional internal, external and/or remote user devices or systems without departing from the invention.

With reference to FIG. 2F, at step 226, communication customization computing platform 110 may execute the machine learning model. For instance, communication customization computing platform 110 may input, to the machine learning model, the received user specific response data (e.g., from internal entity computing system 120, external entity computing system 160 and/or remote user computing device 150). The machine learning model may be executed and the user specific response data analyzed to identify patterns or sequences in the data in order to output one or more categories to be associated with the user.

For instance, if user data indicates the user is a financial analyst and enjoys researching current market trends, the user may be associated with a “financial” category. In another example, if user transaction data indicates that the user spends often for online games, the user may be associated with a “gaming” category. Various other categories may be identified for a user without departing from the invention.

At step 227, the communication customization computing platform 110 may generate a category of the user (e.g., based on an output from the machine learning model). In some examples, more than one category may be identified and a user may be prompted to select one or rank the categories in order of interest to the user. In some examples, generation of the category may cause the communication customization computing platform 110 to transmit a notification to the user requesting confirmation of the category as accurate or appropriate. In those examples, the user response received may be used to update or validate the machine learning model (e.g., to optimize the model and improve accuracy).

At step 228, based on the output or identified category, communication customization computing platform 110 may retrieve a communication scheme associated with the category. For instance, communication schemes including default communication settings for a particular category may be generated (e.g., using machine learning analysis of historical data indicating or identifying communication preferences of users associated with various categories. In some examples, one or more clustering algorithms may be used to identify categories and associated communication schemes from the historical data). The communication schemes may be stored (e.g., in database 112h) and, upon identification of a category for a user, an associated communication scheme may be retrieved.

At step 229, communication customization computing platform 110 may execute the retrieved communication scheme. For instance, the retrieved communication scheme may be associated with or applied to the user. Further, at step 230, one or more instructions causing execution of the identified communication scheme by one or more systems or devices may be generated. For instance, one or more instructions to modify communication settings within one or more systems or applications, or for one or more devices, to align with settings of the communication scheme may be generated.

With reference to FIG. 2G, at step 231, communication customization computing platform 110 may transmit or send the generated instruction to one or more computing devices or systems to implement or execute. For instance, the generated instruction may be sent to one or more of internal entity computing system 120, internal entity computing device 130, and/or remote user computing device 150.

At step 232, the one or more devices or systems may receive and execute the instructions. For instance, internal entity computing system 120 may receive and execute the instruction thereby modifying settings for items like, type of communication frequency of communication, terminology used, and the like, for one or more systems or applications hosted or supported by internal entity computing system (e.g., to align with the communication scheme identified) at step 233.

In another example, at step 232, internal entity computing device 130, which may, e.g., be a self-service kiosk of the enterprise organization, may receive and execute the instruction thereby modifying settings for terminology used in communications with the user, appearance of user interfaces, volume or pitch of audio provided, availability of adaptions of the device, or the like, at step 233.

In yet another example, at step 232, remote user computing device 150 may receive and execute the instruction thereby causing the remote user computing device 150 to modify one or more applications executing on the remote user computing device 150 at step 233.

As step 234, additional user specific data may be received from one or more systems or devices. For instance, as a user conducts transactions, interacts with social media platforms, requests new products or services, and the like, additional user specific data may be captured by a respective device or system and transmitted to the communication customization computing platform 110. In some examples, additional or subsequent user specific data may be received from one or more of internal entity computing system 120, internal entity computing device 130, remote user computing device 150 and/or external entity computing system 160.

At step 235, communication customization computing platform 110 may execute the machine learning engine using the additional user specific data as inputs to output one or more communication scheme customizations for the user (e.g., one or more modifications to the default communication scheme executed for the user to make the communication scheme customized to this particular user).

With reference to FIG. 2H, at step 236, based on execution of the machine learning model, communication customization computing platform 110 may identify one or more communication scheme customizations. For instance, based on the user specific data analyzed using the machine learning model, one or more modifications to the default communication scheme may be identified. In some examples, the modifications or further customizations may include a change in frequency of communication, channel of communication, type of communication, or the like. Based on identifying the one or more communication channel customizations, an instruction to execute the one or more customizations may be generated by the communication customization computing platform 110.

At step 237, communication customization computing platform 110 may transmit or send the generated instruction to one or more computing devices or systems to implement or execute. For instance, the generated instruction may be sent to one or more of internal entity computing system 120, internal entity computing device 130, and/or remote user computing device 150.

At step 238, the one or more devices or systems may receive and execute the instructions. For instance, internal entity computing system 120 may receive and execute the instruction thereby further modifying settings for items like, type of communication frequency of communication, terminology used, and the like, for one or more systems or applications hosted or supported by internal entity computing system (e.g., to align with the modified or customized communication scheme identified) at step 239.

In another example, at step 238, internal entity computing device 130, which may, e.g., be a self-service kiosk of the enterprise organization, may receive and execute the instruction thereby further modifying settings (e.g., modifying the settings executed when implementing the communication scheme) for terminology used in communications with the user, appearance of user interfaces, volume or pitch of audio provided, availability of adaptions of the device, or the like, at step 239. For instance, terminology even more closely tailored to interests of the user may be used, volume or pitch may be further adjusted, or the like.

In yet another example, at step 238, remote user computing device 150 may receive and execute the instruction thereby causing the remote user computing device 150 to modify one or more applications executing on the remote user computing device 150 at step 239.

At step 240, further user specific data may be received from one or more systems or devices (e.g., internal entity computing system 120, internal entity computing device 130, remote user computing device 150, external entity computing system 160, or the like). Similar to the data received above, the data may be received as the user interacts with the one or more systems or devices and may be continuously transmitted to the communication customization computing platform 110 or transmitted in batch processes.

With reference to FIG. 2I, at step 241, communication customization computing platform 110 may detect a triggering event. For instance, machine learning may be used to analyze the further user specific data received, e.g., at step 240. The user specific data may be input to the machine learning model and the model executed. In analyzing the data, the machine learning model may detect an anomaly in the pattern or sequence of data that may indicate a triggering event, such as a change in job, new interest of hobby, change in life status, or the like.

In response to detecting the triggering event, at step 242, a notification requesting user input confirming a current user category may be generated and transmitted or sent to remote user computing device 150. For instance, FIG. 5 illustrates one example interface 500, that includes a request for a user to confirm the current category of association. The interface 500 includes identification of the current category, as well as an option to confirm and multiple options to change categories (e.g., to a recommended category generated by, e.g., the machine learning model, or to another category that may be selected by the user). Although two options to change categories are shown, more options may be provided and, in some examples, a user may select multiple categories for association and may rank them by preference.

In some examples, transmitting or sending the notification may cause the notification to be displayed by a display of remote user computing device 150.

At step 243, remote user computing device 150 may receive and display the notification requesting confirmation of category assignment or association.

At step 244, remote user computing device may receive user input selecting one or more options from the notification (e.g., selecting or inputting a request to confirm the current category or change the current category to a different category). The remote user computing device 150 may generate user response data from the received user input.

At step 245, the remote user computing device 150 may transmit or send the user response data to the communication customization computing platform 110.

With reference to FIG. 2J, at step 246, communication customization computing platform 110 may receive the user response data and process the data. For instance, at step 247, communication customization computing platform 110 may execute the machine learning model using most recently received user specific data, as well as the user response data, to identify a new category and/or generate one or more communication scheme customizations (e.g., to a new or second communication scheme identified based on the user response data, further modifications based on confirmation of category, or the like).

At step 248, one or more instructions to modify communication settings for the user may be generated by the communication customization computing platform 110 and transmitted or sent to one or more computing devices or systems to implement or execute. For instance, the generated instruction may be sent to one or more of internal entity computing system 120, internal entity computing device 130, and/or remote user computing device 150.

At step 249, the one or more devices or systems may receive and execute the instructions. For instance, internal entity computing system 120 may receive and execute the instruction thereby further modifying settings for items like, type of communication frequency of communication, terminology used, and the like, for one or more systems or applications hosted or supported by internal entity computing system (e.g., to align with the modified or customized communication scheme identified) at step 250 based on, for instance, the newly identified or confirmed category, the additional processed data, or the like.

In another example, at step 249, internal entity computing device 130, which may, e.g., be a self-service kiosk of the enterprise organization, may receive and execute the instruction thereby further modifying settings (e.g., modifying the customized communication scheme settings) for terminology used in communications with the user, appearance of user interfaces, volume or pitch of audio provided, availability of adaptions of the device, or the like, at step 250 based on, for instance, the newly identified or confirmed category, the additional processed data, or the like.

In yet another example, at step 249, remote user computing device 150 may receive and execute the instruction thereby causing the remote user computing device 150 to modify one or more applications executing on the remote user computing device 150 at step 250, based on, for instance, the newly identified or confirmed category, the additional processed data, or the like.

With reference to FIG. 2K, at step 251, communication customization computing platform may update and/or validate the machine learning model. For instance, based on user specific data (e.g., received in steps 234 and/or 240), user response data (e.g., received in step 246), and the like, the machine learning model may be updated and/or validated to continuously improve accuracy of the model, optimize output of the model, and the like.

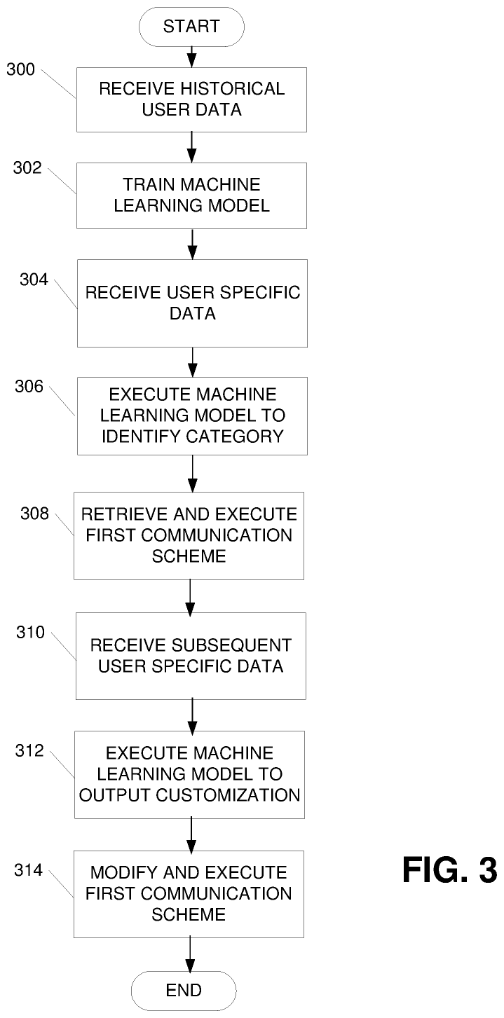

FIG. 3 is a flow chart illustrating one example method of communication customization in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, a computing platform may receive, from a plurality of data sources, historical user data. For instance, historical user data associated with transaction histories, interests, hobbies, job function, demographics, public records, and the like, may be received by the computing platform 110. Accordingly, the plurality of data sources may include self-reported data received from a user computing device, internal data sources (e.g., internal to the enterprise organization associated with the computing platform 110), and/or external data sources (e.g., sources external to the enterprise organization).

At step 302, the computing platform may train a machine learning model using the received historical data. For instance, the machine learning model may be trained to identify patterns or sequences in data based on the historical data received. The machine learning model may be trained to receive user specific data as inputs and output one or more categories for association with the user, communication scheme customizations, and the like.

At step 304, user specific data may be received by the computing platform. For instance, user specific data for a first user may be received from one or more data sources (e.g., self-reported data, sources internal to the enterprise organization such as internal entity computing system 120, sources external to the enterprise organization such as external entity computing system 160, and the like).

At step 306, the machine learning model may receive, as inputs, the user specific data and, upon execution of the machine learning model, may output a recommended category for association with the first user. The recommended category may be based on interests, hobbies, employment, or the like, of the user.

Based on the recommended category, at step 308, the computing platform may retrieve a first communication scheme associated with the recommended category and execute the first communication scheme. In some examples, executing the first communication scheme may include generating an instruction causing one or more computing systems or devices to modify at least one setting associated with communication between the one or more computing systems or devise and the first user (e.g., frequency of communication, type of communication, channel of communication, and the like). The generated instruction may be transmitted to the one or more computing systems or devices and may be executed to modify the at least one setting.

At step 310, the computing platform may receive subsequent user specific data for the first user. For instance, as the user conducts transactions, interacts with social media platforms, and the like, user specific data may be received by the computing platform.

At step 312, the machine learning model may be executed using the subsequent user specific data as inputs to output a first user specific customization to the first communication scheme. For instance, based on the subsequent user specific data, the first communication scheme may be customized for the first user.

At step 314, the first communication scheme may be modified based on the first user specific customization and the modified first communication scheme may be executed. In some examples, modifying the first communication scheme may include generating an instruction causing one or more computing systems or devices to modify at least one setting associated with one of: a preferred channel of communication or a frequency of communication with the first user. The generated instruction may be transmitted to the one or more computing systems or devices and executed to modify a setting associated with one of: the preferred channel of communication or the frequency of communication with the first user.

As discussed herein, aspects described are directed to providing customized communication between enterprise organization systems and users. By categorizing a user based on user data, a default communication scheme associated with the user may be retrieved and executed. As a user continues to interact with one or more systems or devices (e.g., via transactions, social media, or the like) additional user specific data may be captured and analyzed to modify the default communication scheme to a customized communication scheme particular to the user.

As discussed, the arrangements described include a dynamic feedback loop that may continuously update or validate the machine learning model to improve accuracy and/or optimize the model. Further, self-reported user data may be used to further customize the communication scheme in order to further tailor communications to a particular user or user's needs (e.g., for neurodiverse users, for users requiring adaptive measures, or the like). A user may indicate particular needs or preferences which may be used to customize communications. For instance, if a user indicates that email as a communication channel is overwhelming, the system may customize communication to be performed via regular mail and as infrequently as possible (e.g., consolidate messaging, and the like). In another example, if a user indicates that they prefer to limit telephone contact, communications may be transmitted via SMS or email. Various other examples may be used without departing from the invention.

In some examples, the feedback provided to update or validate the machine learning model may include user input (e.g., user input requesting a particular category, input confirming an identified category, input prioritizing categories, and the like). Additionally or alternatively, the feedback may be received via user specific data generated and/or received from one or more systems or devices (e.g., based on user interaction with the one or more systems or devices. In some examples, the feedback may include particular channels or types of channels the user interacted with more frequently than others, frequency of interactions, and the like.

In some arrangements, the feedback may include terminology used or topics of inquiries received. For instance, if a user has several requests using the same terminology or in a same area of interest (e.g., small business management), the user communication scheme may be customized to use terminology suitable for small business owners, ask questions that may prompt the user to perform a service for the small business or revise a strategy, or the like. In some examples, a communication packet may be executed for users in particular categories to modify the terms used in communications from the enterprise organization to the user (e.g., in letters, emails, online chats, or the like).

In some examples, executing a communication scheme or modified communication scheme may be performed using a plug-in for existing communication channels. For instance, a plug-in modifying terminology to be used for one or more categories of people may be provided to an enterprise organization customer service system. Accordingly, when communication occurs between the enterprise organization and a user, the terminology may be customized or tailored to the user, the products and/or services offered may be tailored to the user, and the like.

As discussed herein, one or more triggering events may be detected. The triggering events may be detected based on anomalies in transaction data (e.g., a user's spending habits have changed), social media interactions, and the like. For instance, changes in how someone earns money (e.g., employer data, frequency of deposits, and the like) and/or how someone spends money (e.g., transaction types, and the like) may indicate a change in job, life status, or the like, that may prompt interaction with the user to ensure categorization and customization are still correct. In some examples, a notification may include a request for a user to confirm occurrence of the triggering event or confirm that a current category/customization is appropriate for the user.

As discussed herein, customization of communications may include customizing frequency of communication, channels of communication, terminology used in communications, and the like. Further, the customized communications may include identification of particular products, services, considerations, or the like, that might be appropriate for a user in a particular category. For instance, if a user has recently changed from a salaried position with regular direct deposits from the same employer, to more sporadic deposits received from multiple employers, the user may be prompted to revisit a tax strategy, saving strategy, or the like. Further, in some examples, deposits from particular employers or types of employers (e.g., talent agencies) may indicate that the user works in the arts and might appreciate communications geared toward artists (e.g., some artists appreciate data presented in more visual formats and, accordingly, user data provided to a user in an artist category may be communications customized to more graphic representations than other users).

The arrangements described herein provide a holistic customization experience for a user by identifying not only objective data about the user but subject data, such as hobbies, interesting, and the like, and modifying communications between the user and the enterprise organization based on whole body of data. By using machine learning, even modest changes may be detected and further customizations generated for the particular user to ensure an optimal communication experience. In some examples, customization of communication schemes may include modest changes until at least a threshold amount of data for a particular user has been analyzed. Once the threshold amount of data is reached, a confidence in the user data and predictions may increase and additional or more substantial customizations may be executed for the particular user.

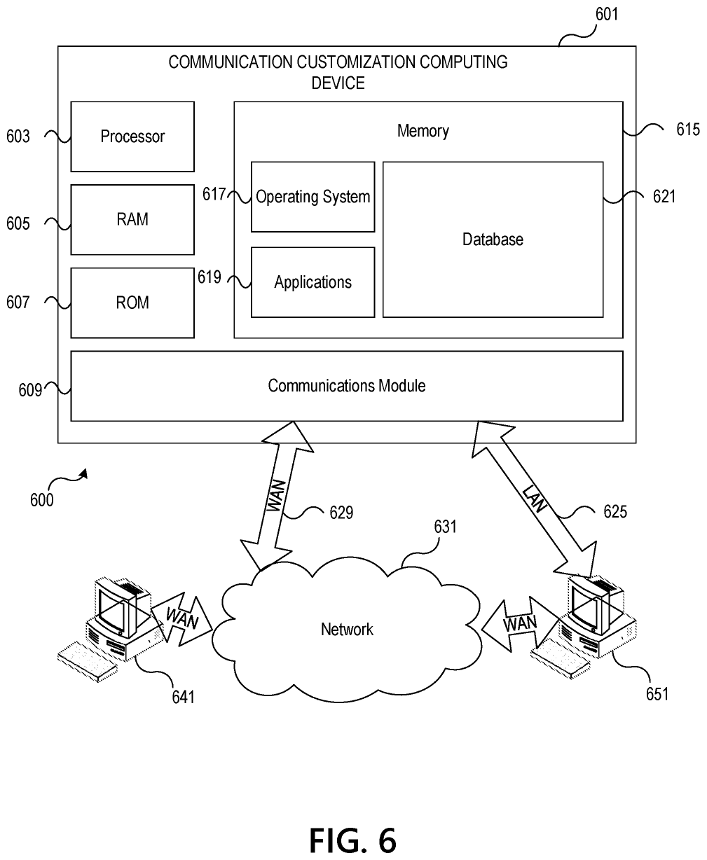

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include communication customization computing device 601 having processor 603 for controlling overall operation of communication customization computing device 601 and its associated components, including Random Access Memory (RAM) 605, Read-Only Memory (ROM) 607, communications module 609, and memory 615. Communication customization computing device 601 may include a variety of computer readable media. Computer readable media may be any available media that may be accessed by communication customization computing device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by communication customization computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on communication customization computing device 601. Such a processor may execute computer-executable instructions stored on a computer-readable medium.

Software may be stored within memory 615 and/or storage to provide instructions to processor 603 for enabling communication customization computing device 601 to perform various functions as discussed herein. For example, memory 615 may store software used by communication customization computing device 601, such as operating system 617, application programs 619, and associated database 621. Also, some or all of the computer executable instructions for communication customization computing device 601 may be embodied in hardware or firmware. Although not shown, RAM 605 may include one or more applications representing the application data stored in RAM 605 while communication customization computing device 601 is on and corresponding software applications (e.g., software tasks) are running on communication customization computing device 601.

Communications module 609 may include a microphone, keypad, touch screen, and/or stylus through which a user of communication customization computing device 601 may provide input, and may also include one or more of a speaker for providing audio output and a video display device for providing textual, audiovisual and/or graphical output. Computing system environment 600 may also include optical scanners (not shown).

Communication customization computing device 601 may operate in a networked environment supporting connections to one or more other computing devices, such as computing device 641 and 651. Computing devices 641 and 651 may be personal computing devices or servers that include any or all of the elements described above relative to communication customization computing device 601.

The network connections depicted in FIG. 6 may include Local Area Network (LAN) 625 and Wide Area Network (WAN) 629, as well as other networks. When used in a LAN networking environment, communication customization computing device 601 may be connected to LAN 625 through a network interface or adapter in communications module 609. When used in a WAN networking environment, communication customization computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive historical user data from a plurality of data sources;
train, using the historical user data, a machine learning model to recommend a category of user and one or more customization recommendations for one or more systems;
receive user specific data;
execute the machine learning model using the user specific data as inputs to output a recommended category of a first user;
retrieve, based on the recommended category of the first user, a first communication scheme to execute for the first user, wherein the first communication scheme is associated with the recommended category;
execute the first communication scheme for the first user;
receive subsequent user specific data for the first user;
execute the machine learning model using the subsequent user specific data as inputs to generate a first user specific customization to the first communication scheme;
modify the first communication scheme to include the first user specific customization; and
execute the modified first communication scheme, wherein executing the modified first communication scheme includes modifying one of: a preferred channel of communication or a frequency of communication with the first user.

2. The computing platform of claim 1, wherein executing the first communication scheme for the first user includes:
generating an instruction causing a computing system to modify at least one setting associated with communication between the computing system and the first user; and
transmitting the generated instruction to the computing system, wherein transmitting the instruction to the computing system causes the computing system to execute the instruction and modify the at least one setting associated with communication between the computing system and the first user.

3. The computing platform of claim 1, wherein executing the modified first communication scheme further includes:
generating an instruction causing a computing system to modify at least one setting associated with one of: the preferred channel of communication or the frequency of communication with the first user; and
transmitting the generated instruction to the computing system, wherein transmitting the instruction to the computing system causes the computing system to execute the instruction and modify a setting associated with one of: the preferred channel of communication or the frequency of communication with the first user.

4. The computing platform of claim 1, further including instructions that, when executed, cause the computing platform to:
detect a triggering event;
responsive to detecting the triggering event, generate a request for user input confirming the recommended category for the first user;
responsive to receiving the user input confirming the recommended category for the first user, further modify the modified first communication scheme based on the triggering event; and
execute the further modified first communication scheme.

5. The computing platform of claim 4, responsive to receiving user input selecting a category other than the recommended category, retrieving a second communication scheme based on the category other than the recommended category and executing the second communication scheme.

6. The computing platform of claim 1, wherein the recommended category is based on one of: user employment area, user hobby area, or user interest area.

7. The computing platform of claim 1, further including instructions that, when executed, cause the computing platform to:
update the machine learning model based on the received subsequent user specific data for the first user.

8. A method, comprising:
receiving, by a computing platform, the computing platform having at least one processor and memory, and from a plurality of data sources, historical user data;
training, by the at least one processor and using the historical user data, a machine learning model to recommend a category of user and one or more customization recommendations for one or more systems;
receiving, by the at least one processor, user specific data;
executing, by the at least one processor, the machine learning model using the user specific data as inputs to output a recommended category of a first user;
retrieving, by the at least one processor and based on the recommended category of the first user, a first communication scheme to execute for the first user, wherein the first communication scheme is associated with the recommended category;
executing, by the at least one processor, the first communication scheme for the first user;
receiving, by the at least one processor, subsequent user specific data for the first user;
executing, by the at least one processor, the machine learning model using the subsequent user specific data as inputs to generate a first user specific customization to the first communication scheme;
modifying, by the at least one processor, the first communication scheme to include the first user specific customization; and
executing, by the at least one processer, the modified first communication scheme, wherein executing the modified first communication scheme includes modifying one of: a preferred channel of communication or a frequency of communication with the first user.

9. The method of claim 8, wherein executing the first communication scheme for the first user includes:
generating, by the at least one processor, an instruction causing a computing system to modify at least one setting associated with communication between the computing system and the first user; and
transmitting, by the at least one processor, the generated instruction to the computing system, wherein transmitting the instruction to the computing system causes the computing system to execute the instruction and modify the at least one setting associated with communication between the computing system and the first user.

10. The method of claim 8, wherein executing the modified first communication scheme further includes:
generating, by the at least one processor, an instruction causing a computing system to modify at least one setting associated with one of: the preferred channel of communication or the frequency of communication with the first user; and
transmitting, by the at least one processor, the generated instruction to the computing system, wherein transmitting the instruction to the computing system causes the computing system to execute the instruction and modify a setting associated with one of: the preferred channel of communication or the frequency of communication with the first user.

11. The method of claim 8, further including:
detecting, by the at least one processor, a triggering event;
responsive to detecting the triggering event, generating, by the at least one processor, a request for user input confirming the recommended category for the first user;
responsive to receiving the user input confirming the recommended category for the first user, further modifying, by the at least one processor, the modified first communication scheme based on the triggering event; and
executing, by the at least one processor, the further modified first communication scheme.

12. The method of claim 11, responsive to receiving user input selecting a category other than the recommended category, retrieving, by the at least one processor, a second communication scheme based on the category other than the recommended category and executing, by the at least one processor, the second communication scheme.

13. The method of claim 8, wherein the recommended category is based on one of:
user employment area, user hobby area, or user interest area.

14. The method of claim 8, further including:
updating, by the at least one processor, the machine learning model based on the received subsequent user specific data for the first user.

15. One or more non-transitory computer-readable media storing instructions that, when executed by a computing platform comprising at least one processor, memory, and a communication interface, cause the computing platform to:
receive historical user data from a plurality of data sources;
train, using the historical user data, a machine learning model to recommend a category of user and one or more customization recommendations for one or more systems;
receive user specific data;
execute the machine learning model using the user specific data as inputs to output a recommended category of a first user;
retrieve, based on the recommended category of the first user, a first communication scheme to execute for the first user, wherein the first communication scheme is associated with the recommended category;
execute the first communication scheme for the first user;
receive subsequent user specific data for the first user;
execute the machine learning model using the subsequent user specific data as inputs to generate a first user specific customization to the first communication scheme;
modify the first communication scheme to include the first user specific customization; and
execute the modified first communication scheme, wherein executing the modified first communication scheme includes modifying one of: a preferred channel of communication or a frequency of communication with the first user.

16. The one or more non-transitory computer-readable media of claim 15, wherein executing the first communication scheme for the first user includes:
generating an instruction causing a computing system to modify at least one setting associated with communication between the computing system and the first user; and
transmitting the generated instruction to the computing system, wherein transmitting the instruction to the computing system causes the computing system to execute the instruction and modify the at least one setting associated with communication between the computing system and the first user.

17. The one or more non-transitory computer-readable media of claim 15, wherein executing the modified first communication scheme further includes:
generating an instruction causing a computing system to modify at least one setting associated with one of: the preferred channel of communication or the frequency of communication with the first user; and
transmitting the generated instruction to the computing system, wherein transmitting the instruction to the computing system causes the computing system to execute the instruction and modify a setting associated with one of: the preferred channel of communication or the frequency of communication with the first user.

18. The one or more non-transitory computer-readable media of claim 15, further including instructions that, when executed, cause the computing platform to:
detect a triggering event;
responsive to detecting the triggering event, generate a request for user input confirming the recommended category for the first user;
responsive to receiving the user input confirming the recommended category for the first user, further modify the modified first communication scheme based on the triggering event; and
execute the further modified first communication scheme.

19. The one or more non-transitory computer-readable media of claim 18, responsive to receiving user input selecting a category other than the recommended category, retrieving a second communication scheme based on the category other than the recommended category and executing the second communication scheme.

20. The one or more non-transitory computer-readable media of claim 15, further including instructions that, when executed, cause the computing platform to:
update the machine learning model based on the received subsequent user specific data for the first user.
